(19) United States
(12) Patent Application Publication
(10) Pub. No.: US 2009/0155405 A1
(43) Pub. Date: Jun. 18, 2009

(54) Injection-molding nozzle, in particular hot-runner nozzle, for an injector

(75) Inventor: Herbert Günther, Allendorf/Rennertehausen (DE)

Correspondence Address: K.F. ROSS P.C., 5683 RIVERDALE AVENUE, SUITE 203 BOX 900, BRONX, NY, 10471-0900, US

(73) Assignee: GUNTHER HEISSKANA TECHNIK GMBH, FRANKENBERG (DE)

(21) Appl. No.: 12/302,340

(22) PCT Filed: May 23, 2007
(86) PCT No.: PCT/EP07/04546

§ 371 Date: Nov. 25, 2008

(30) Foreign Application Priority Data
Jun. 8, 2006 (DE) 10-2006-026-579.3

(51) Int. Cl. B29C 45/74

(52) U.S. Cl. 425/549

(57) ABSTRACT

In the case of an injection nozzle, in particular hot-runner nozzle (7), for arrangement in an injection mould (11) which has a relatively large number of plates as a function of the configuration, and which has, on its solid mould side (I), at least one platen (4) and one feed plate (5), and, on its mould side (II) at least one cavity plate (2), at the mould cavity (3) of which the nozzle point (8) is used, where the hot-runner nozzle (7) has been formed with a housing collar (11) and has been formed in a central material tube with a flow channel (9) for a material melt leading to the nozzle point (8), and has connections for a heating system (16) and/or cooling system and temperature sensor (17), the injection nozzle (7) has been incorporated into the injection mould (1) from the mould side (II) with sealing with respect to the feed plate (5).

The invention relates to an injection-molding nozzle, in particular a hot-runner nozzle, for provision in an injection-molding injector having, depending on configuration, a relatively large number of plates, and having on its fixed side at least one mounting plate or mold-clamping plate and one distribution plate, and on its mold side has at least one mold plate forming a mold cavity into which the nozzle tip opens, the hot-runner nozzle being provided with a housing collar, and in a concentric material tube being provided with a flow passage for a molten material opening into the nozzle tip, and having connections for a heating element and temperature sensor.

Such an injection-molding nozzle is known from DE 195 42 237 [U.S. Pat. No. 5,507,634], which is provided as a hot-runner nozzle having an integrated electric heating element, and having a central borehole as a flow passage for conveying the thermoplastic melt to the nozzle tip and then into the cavity of a cooled mold or a separable mold block having the mold cavity provided in a mold plate. The mold plate may form multiple mold cavities, and the injection mold may be correspondingly provided with multiple injection-molding nozzles. At its rear end the nozzle housing has a flange part which is accommodated in a seat in a plate on the fixed side for fixing the injection-molding nozzle in place.

In a hot runner or cold runner nozzle used in injection molds and known from DE 100 04 072 [U.S. Pat. No. 6,805,549], to feed a free-flowing mass to a separable mold block (mold cavity) at a specifiable temperature under high pressure the nozzle body has at least one essentially flat side surface on which a flat heating and/or cooling device is mounted.

Installation of the known hot runner or cold runner nozzles in the fixed mold plate, generally on the distribution plate for the molten material, has proven to be disadvantageous. Any leaks between the injection-molding nozzle and the distributor may result in uncontrolled spreading of the molten material and may damage the injection-molding nozzle and the connecting cables.

The object of the invention, therefore, is to provide a design for a standard injection-molding nozzle, in particular a hot-runner nozzle, in which leaks which occur between the nozzle and the distributor are not able to adversely affect the nozzle and cabling.

This object is achieved according to the invention by the fact that the injection-molding nozzle is incorporated into the injection mold from the mold side and is sealed with respect to the distribution plate. Aside from the fact that by use of the measure according to the invention the installation of the injection-molding nozzles is significantly simplified because the injection mold is freely accessible from the front, in particular it is ensured that melt leaks are not able to reach the injection-molding nozzle, since the injection-molding nozzle is sealed with respect to the distribution plate as well as the overall mold side, and thus, with respect to additional plates adjoining the distribution plate in the injection direction, such as a frame plate or intermediate plate which accommodates the injection-molding nozzle. Thus, the leaks are not able to damage the cables and connections for the heating and/or cooling element and temperature sensor.

One preferred embodiment of the invention provides a nozzle design in which the rear end of the nozzle housing facing away from the nozzle tip is provided with an annular seal lip which seals a through hole provided with a precise fit in an intermediate plate, connected in front of the distribution plate in the injection direction, for accommodating the rear end of the nozzle housing. Compared to an optional seal ring or the like, the seal lip joined to the end of the nozzle housing has the advantage of a consistently accurately positioned, precise fit in the through hole. Upon insertion of the injection-molding nozzle into the through hole, the outer lip effectively prevents any emerging plastic or molten metal between the distributor and nozzles from entering the fixed side at the front end of the nozzle.

According to one advantageous embodiment of the invention, the intermediate plate is provided with a seat, open toward the front in the injection direction, for the centering accommodation of the housing collar for the injection-molding nozzle. When it is inserted, the injection-molding nozzle is thus fixed in place via the larger housing collar and guided into its installation position.

When the seat is preferably provided with a cavity that extends orthogonally of the injection direction and in which the heating-element and temperature-sensor connections are accommodated, the connections and cables may be housed in a protected region of the mold. As the result of the installation according to the invention with sealing of the nozzle and shielded housing of the heating-element and/or temperature-sensor connections together with their cables, these components may advantageously be protected from temperature influences from the hot distributor.

The cavity is mechanically separated from the installation space of the distributor for the distribution plate.

According to one proposal of the invention, at least the housing for the injection-molding nozzle, which provides the end of the nozzle housing together with the housing collar, is made of titanium. A favorable temperature profile for the melt may be achieved in this manner.

Further features and particulars of the invention result from the claims and the following description of one illustrated embodiment of the invention illustrated in the drawings, in which:

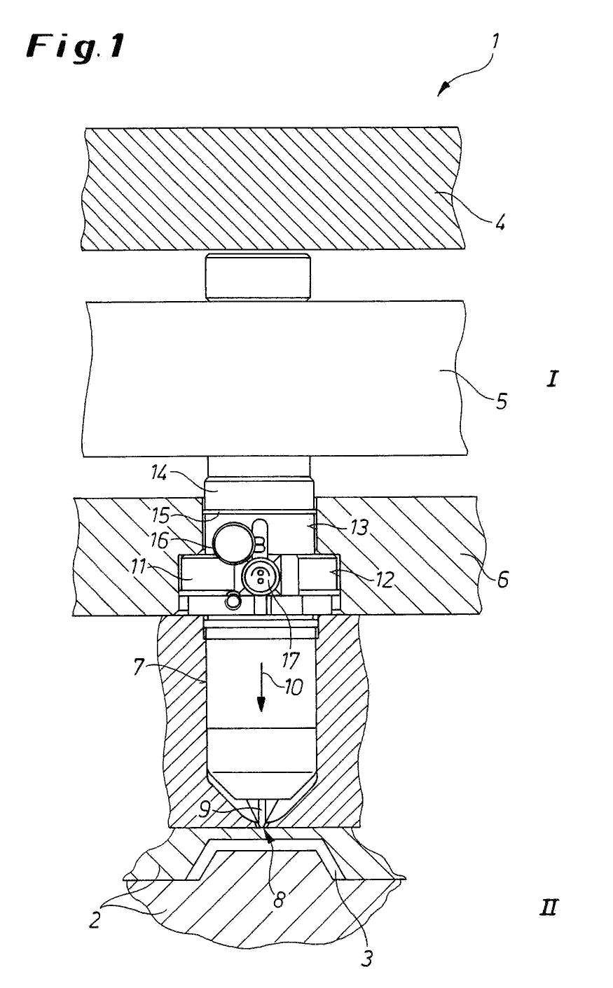

FIG. 1 is a schematic illustration of an injection-molding nozzle installed in an injection mold, in a partial cross section;

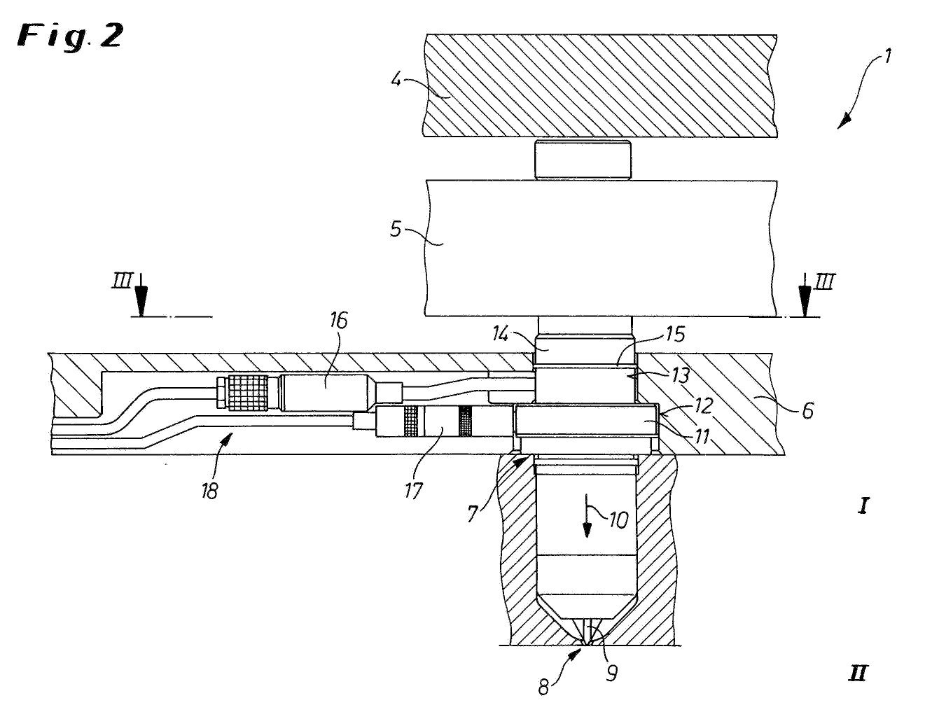

FIG. 2 is the subject matter of FIG. 1 as a partial cross section in a side view;

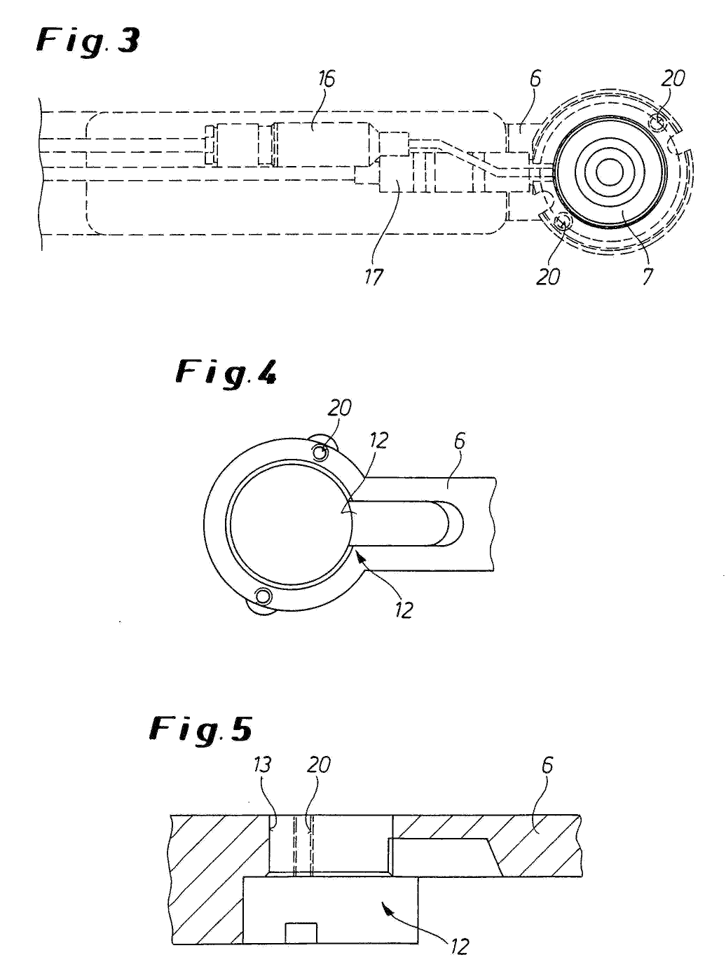

FIG. 3 is the subject matter of FIG. 2 seen in direction III-III;

FIG. 4 is a partial view of the intermediate plate of the injection mold which accommodates the hot-runner nozzle; and

FIG. 5 is a longitudinal section of FIG. 4.

An injection mold 1 illustrated in the drawing comprises multiple plates on its fixed back side I, and on its front mold side II has a separable mold block together with a pair of mold parts 2 forming a mold cavity 3 (see FIG. 1). Of these, a mounting plate or mold-clamping plate 4, a distribution plate 5 with flow passages (not illustrated), and a frame plate or intermediate plate 6 are shown on the fixed side I. An injection-molding nozzle designed as a hot-runner nozzle 7 in the illustrated embodiment is inserted from the front into the injection mold 1 from the mold side II. This injection-molding nozzle has a flow passage 9 in a central shell tube opening into a nozzle tip 8 for the molten metal fed from the distribution plate 5 in the injection molding direction 10 from the nozzle tip 8 into the cavity 3 in the mold plate 2, as shown in FIG. 1.

The injection-molding nozzle or hot-runner nozzle 7 together with a large housing collar 11 are inserted into an open seat 12 (see FIGS. 4 and 5) in the intermediate plate 6 that opens to the front in the injection direction 10. The seat 12 merges with a through hole 13 through which a rear end 14 of the housing of the hot-runner nozzle 7 projects adjacent the distribution plate 5.

The rear end 14 of the housing is provided with a seal in the form of an annular lip 15 that fits snugly in the through hole 13 of the seat 12 in the intermediate plate 6, as shown in FIGS. 1 and 2. By use of the seal lip 15 shown in the illustrated embodiment, the seal prevents molten material that may inadvertently emerge between the distributor 5 and the nozzle at the fixed side I from spreading to the hot-runner nozzle 7 in the injection direction 10.

As a result of the seal formed by the seal lip 15, heating-element and temperature-sensor connections 16 and 17 together with their cables are completely undamaged by any molten metal leaks.

The protected installation position of the heating-element and temperature-sensor connections 16 and 17 is further benefited by the fact that the connections are accommodated in a cavity 18 in the intermediate plate 6 that extends orthogonally of the injection direction 10 thermally shielded from the distribution plate 5. For centering and guiding the hot-runner nozzle 7 when it is inserted into the seat 12 in the intermediate plate 6, the housing collar 11 and the rear end 14 of the nozzle housing together with the seal lip 15 in this region are guided into the borehole 13. After insertion into the seat 12 in the intermediate plate 6, the hot-runner nozzle 7 is screwed to the intermediate plate 6, threaded holes 20 (see FIGS. 3 through 5) being provided in the installation position.

### LIST OF REFERENCE CHARACTERS

1 Injection mold
2 Mold plate
3 Mold cavity
4 Mold-clamping plate
5 Distribution plate
6 Intermediate plate
7 Injection-molding nozzle/hot-runner nozzle
8 Nozzle tip
9 Flow passage
10 Flow direction (arrow)
11 Housing collar
12 Seat
13 Through hole
14 Rear end of housing
15 Seal lip
16 Heating-element connection
17 Temperature-sensor connection
18 Cavity
19
20 Threaded hole
I Fixed side
II Mold side

1-7. (canceled)

8. An injection-molding nozzle assembly comprising:
a front mold plate formed with a mold cavity;
an intermediate plate behind the mold plate and formed with a forwardly open seat juxtaposed with the cavity;
a distribution plate behind the intermediate plate and adapted to feed a hot melt to the seat in the intermediate plate;
a mounting plate behind the distribution plate;
a nozzle having a front-to-back throughgoing passage, a front end formed as a tip fitting with the mold plate and opening into the cavity, and a rear end formed as a collar held in the seat and formed with an annular outwardly projecting seal lip sealingly engaging an inner surface of the seat; and
an electrical component carried on the nozzle and having an electrical lead-out wire.

9. The nozzle assembly defined in claim 8 wherein the intermediate plate has a throughgoing hole with a large-diameter front portion forming the seat and a small-diameter rear portion connected to the distribution plate, the portions forming a shoulder against which the nozzle bears rearwardly.

10. The nozzle assembly defined in claim 9 wherein the front portion is cylindrical and centered on an axis.

11. The nozzle assembly defined in claim 10 wherein the seal lip extends radially in a plane perpendicular to the axis from the nozzle.

12. The nozzle assembly defined in claim 8 wherein the intermediate plate is formed with a forwardly open cavity extending away from the seat and accommodating the lead-out wire.

13. The nozzle assembly defined in claim 8 wherein the component is a temperature sensor or heater.

14. The nozzle assembly defined in claim 8 wherein the nozzle has a rear end formed of titanium and engaging the distribution plate.

15. The nozzle assembly defined in claim 8 wherein the rear end projects rearwardly from the intermediate plate and engages the distribution plate.
